(19) United States
(12) Patent Application Publication
(10) Pub. No.: US 2009/0093951 A1
(43) Pub. Date: Apr. 9, 2009

(54) Method for determination of Covariance of Indicated Mean Effective Pressure from crankshaft misfire acceleration

(76) Inventors: Daniel L. McKay, Brighton, MI (US); Scott T. Feldmann, South Lyon, MI (US); Christopher H. Knieper, Chesaning, MI (US)

Correspondence Address: DELPHI TECHNOLOGIES, INC., M/C 480-410-202, PO BOX 5052, TROY, MI, 48007, US

(21) Appl. No.: 11/973,099

(22) Filed: Oct. 5, 2007

(51) Int. Cl. G01M 15/11

(52) U.S. Cl. 701/111

(57) ABSTRACT

A method for determining Covariance of Indicated Mean Effective Pressure (COVIMEP) using already-available crankshaft-based measurements that correlate with COVIMEP. Correlated values of COVIMEP are stored as lookup tables in an Engine Control Module for use in continuously determining COVIMEP during engine operation. COVIMEP thus calculated may be used in known fashion as a real time control algorithm variable for such engine control parameters as fueling rate, spark angle advance, exhaust gas recirculation flow, and camshaft phaser advance angle or other engine parameters.

### TECHNICAL FIELD

The present invention relates to control of internal combustion engines; more particularly, to methods for optimizing controllable parameters such as, for example, engine dilution, combustion mixtures and spark timing in such engines; and most particularly, to a method for inferentially determining Covariance of Indicated Mean Effective Pressure (COVIMEP) by calculation from misfire/crankshaft acceleration parameters such as, for example, crankshaft misfire acceleration measurements, in order to control such parameters.

### BACKGROUND OF THE INVENTION

COVIMEP is an accepted standard method for measuring combustion stability in internal combustion engines. The information is valuable in identifying combustion quality and is used extensively in the engine arts in engine dynamometer work to characterize and quantify acceptable and unacceptable combustion performance. COVIMEP is known to be used to determine, for example, the limits of engine dilution (e.g., exhaust gas recirculation, camshaft phasing), spark advance angle, and rich/lean limits to engine fueling.

Although COVIMEP is a valuable parameter for combustion development and controls, its use in real time engine controls has been limited in the prior art because its determination has required expensive and non-durable combustion analysis equipment, and because the prior art methods of measurement have been engine-intrusive (e.g., combustion pressure sensors in the engine heads or spark plugs). Other known methods of combustion quality measurement, such as Ion Sense technology, require expensive hardware upgrades and have not been generally available. Offboard rack-type analysis equipment is bulky, expensive, and non-portable.

What is needed in the art is a method for providing COVIMEP information that does not require additional engine hardware and expense and that can be employed during real time operation of an engine in a vehicle.

It is a principal object of the present invention to provide COVIMEP information from engine parameters and calculations already present in prior art engine control measurements and algorithms.

### SUMMARY OF THE INVENTION

Briefly described, a method for determining COVIMEP in accordance with the present invention uses already-available crankshaft acceleration-based misfire measurements as misfire/crankshaft acceleration parameters which correlate well with COVIMEP. A few examples of these acceleration-based misfire measurements that can be made and used to infer COVIMEP are disclosed in U.S. Pat. No. 6,006,155 and are incorporated herein by reference. Other crankshaft acceleration-based misfire measurements, also referred to as misfire detection points or indices, may be used such as mapped signal misfire detection points characterized in the art as Revolution Mode delta index values, represented herein as Misfire Balanced Index (MFBALIN), and Cylinder Mode values, as known in the art, represented herein as (MFCY1PK and MFCY2PK). Such measurements are known to be made via a toothed crank wheel and one or more tooth sensors adjacent the crank wheel, or by similar electronic means.

Values of COVIMEP as a function of MFBALIN, MFCY1PK, MFCY2PK, or other misfire/crankshaft acceleration parameters, are stored as lookup tables in an Engine Control Module for use in continuously determining COVIMEP during engine operation. COVIMEP thus calculated may be used in known fashion as a real time control algorithm variable for idle adjustment, fueling rate, spark angle advance, exhaust gas recirculation flow, camshaft phaser advance angle, or other powertrain controllable parameters.

### BRIEF DESCRIPTION OF THE DRAWINGS

The present invention will now be described, by way of example, with reference to the accompanying drawings, in which:

FIG. 1 is a graph of dynamometer results showing Average COVIMEP as a function of the Standard Deviation of Engine RPM;

FIG. 2 is a graph of dynamometer results showing both Average COVIMEP and Standard Deviation of Engine RPM as a function of Air/Fuel Ratio;

FIG. 3 is a graph of dynamometer results showing three Average Misfire Indices as a function of Air/Fuel Ratio; and

FIG. 4 is a graph of dynamometer results showing three Average Misfire Indices as a function of Average COVIMEP.

FIG. 5 is a graph of dynamometer results showing optimized crankshaft acceleration misfire index (DELTA) as a function of Average COVIMEP.

The exemplification set out herein illustrates a presently-preferred embodiment of the invention, and such exemplification is not to be construed as limiting the scope of the invention in any manner.

### DESCRIPTION OF THE PREFERRED EMBODIMENTS

As noted above, Indicated Mean Effective Pressure (IMEP) and Covariance of Indicated Mean Effective Pressure (COVIMEP) correlate well with crankshaft acceleration-based misfire measurements that can be determined by calculation and dynamometer experimentation in an engine laboratory. The values obtained can then be programmed into an Engine Control Module as look-up tables for use in controlling a similar engine in real time use conditions.

IMEP is defined as the ratio of the indicated work in Newton meters W₁ divided by the swept volume per cylinder V₂ in cubic meters:

IMEP=W₁/V₂ (Equation 1)

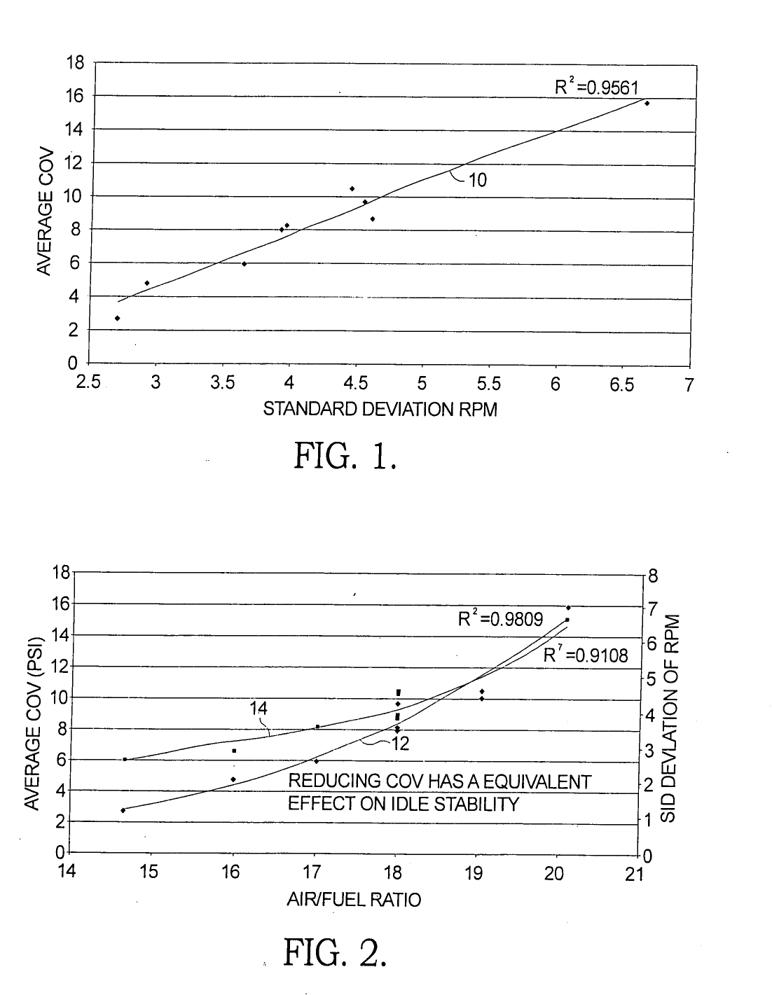

Referring now to FIG. 1, curve 10 is a regression fit of the relationship between experimentally measured COVIMEP and standard deviation of engine revolutions per minute (RPM). The fit has an R² value of 0.9561. A linear relationship and high R² value is expected based on the definition of COVIMEP.

Referring to FIG. 2, curves 12 and 14 are regression fits of the relationships between COVIMEP and commanded engine Air/Fuel Ratio, and between Standard Deviation of RPM and commanded Air/Fuel Ratio, respectively. The respective fits are R²=0.9809 and R²=0.9108. The data in FIGS. 1 and 2 were taken via dynamometer on an engine test stand and show the relationship of COVIMEP and commanded Air/Fuel ratio. As Air/Fuel ratio is increased the combustion quality is degraded, increasing the COVIMEP. Conversely, if the COVIMEP estimate is available, then the air fuel ratio may be inferred.

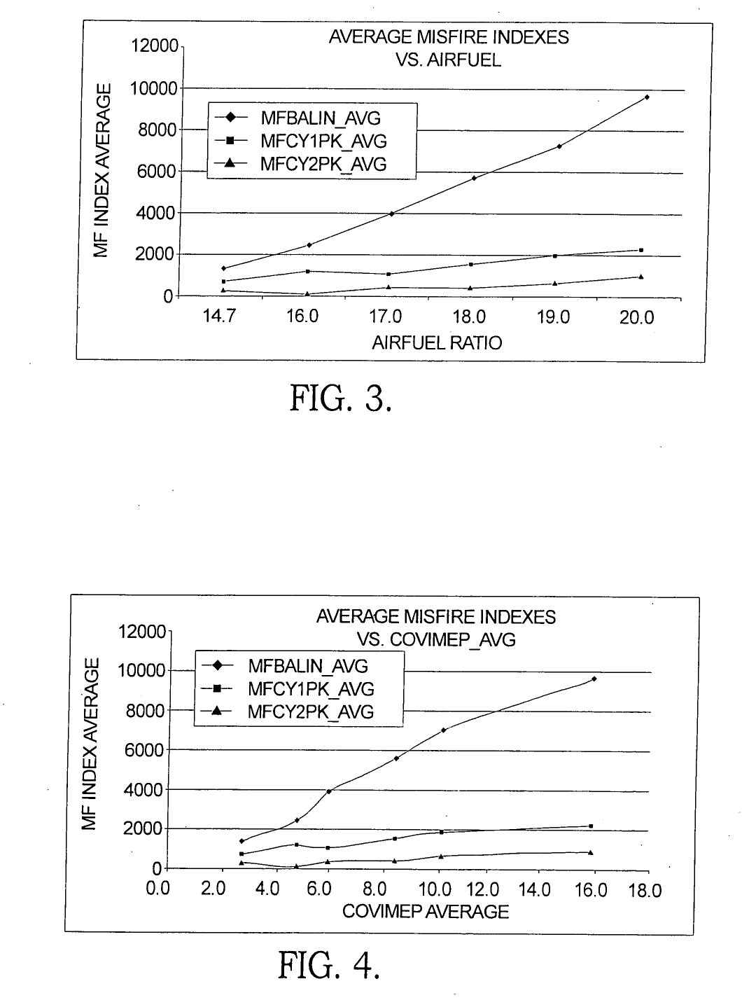

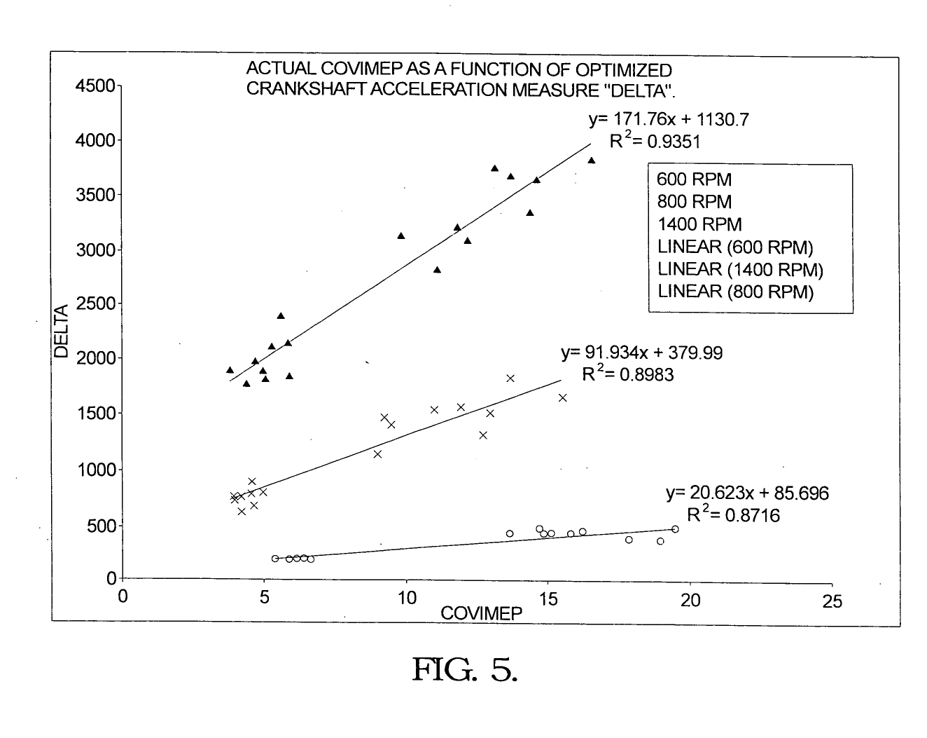

Referring to FIGS. 3 and 4, misfire detection indices are shown as a function of Air/Fuel Ratio (FIG. 3) and Average COVIMEP (FIG. 4) of an exemplar engine. The misfire detection indices are based on engine speed fluctuations which are induced by individual combustion events. MFBALIN, MFCY1PK, and MFCY2PK are examples of these misfire detection indices.

Referring to FIG. 5 an optimized crankshaft acceleration based parameter has been effectively correlated with COVIMEP facilitating accurate COVIMEP estimate lookup. Shown are optimized crankshaft acceleration parameters (DELTA) as a function of COVIMEP. Curve fits for the optimized parameter vary from R² values of 0.87 to 0.93.

Values of COVIMEP, either direct or associated with COVIMEP, as a function of MFBALIN, MFCY1PK, MFCY2PK, or DELTA are stored as lookup tables in an Engine Control Module for use in continuously determining COVIMEP values during real time engine operation. COVIMEP values thus calculated may be used in known fashion as a real time control algorithm variable, as for example, for idle adjustment, fueling rate, spark angle advance, exhaust gas recirculation flow, and camshaft phaser advance angle. Specifically, the calculated COVIMEP value may be used controlling engine fueling for best emissions, drivability or fuel economy and at idle during engine warm-up and after. It may also be used to provide combustion limit feedback as for example, for camshaft phasing, for controlling engine spark timing, for controlling engine dilution including Exhaust Gas Recirculation, for air flow control, for engine speed and/or torque control and for controlling cylinder mixture tumble and swirl.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method for inferring Covariance of Indicated Mean Effective Pressure in an internal combustion engine for use in a control algorithm during real time control of at least one engine function, comprising the steps of:
a) determining a misfire/crankshaft acceleration parameter of said internal combustion engine; and
b) determining the correlation of Covariance of Indicated Mean Effective Pressure to said misfire/crankshaft acceleration parameter for said internal combustion engine.

2. A method in accordance with claim 1 wherein said misfire/crankshaft acceleration parameter is selected from the group consisting of MFBALIN, MFCY1PK, MFCY2PK and DELTA.

3. A method for using Covariance of Indicated Mean Effective Pressure in an internal combustion engine for real time control of at least one engine function, comprising the steps of:
a) selecting a misfire/crankshaft acceleration parameter for said internal combustion engine;
b) determining offline the correlation of Covariance of Indicated Mean Effective Pressure to said misfire/crankshaft acceleration parameter for said internal combustion engine;
c) providing said correlation as a look-up table to an Engine Control Module;
d) determining a value for said misfire/crankshaft acceleration parameter during real time operation of said engine;
e) determining a real time value for Covariance of Indicated Mean Effective Pressure; and
f) using said determined value for Covariance of Indicated Mean Effective Pressure in a control algorithm to set said one engine function.

4. A method in accordance with claim 3 wherein said misfire/crankshaft acceleration parameter is selected from the group consisting of MFBALIN, MFCY1PK, and MFCY2PK.

5. A method in accordance with claim 3 wherein said value for Covariance of Indicated Mean Effective Pressure is a direct value for Covariance of Indicated Mean Effective Pressure.

6. A method in accordance with claim 3 wherein said value for Covariance of Indicated Mean Effective Pressure is a value associated with said Covariance of Indicated Mean Effective Pressure.

7. A method in accordance with claim 3 wherein said misfire/crankshaft acceleration parameter includes a calculation based on variation in engine crankshaft acceleration.

8. A method in accordance with claim 3 wherein said step of determining a real time value for Covariance of Indicated Mean Effective Pressure is carried out at least once per crankshaft revolution of said engine.

9. A method in accordance with claim 3 wherein said at least one engine function is selected from the group consisting of idle adjustment, fueling rate, spark angle advance, exhaust gas recirculation flow, camshaft phaser advance angle, airflow control, rpm control, dilution control, tumble and swirl control, and torque control.
